(19) United States
(12) Patent Application Publication
(10) Pub. No.: US 2026/0111834 A1
(43) Pub. Date: Apr. 23, 2026

(54) DELIVERY DATE ANSWERING SUPPORT METHOD AND DELIVERY DATE ANSWERING SUPPORT SYSTEM

(71) Applicant: Hitachi, Ltd., Tokyo (JP)

(72) Inventors: Atsuki KIUCHI, Tokyo (JP); Kenji OYA, Tokyo (JP); Tazu NOMOTO, Tokyo (JP); Yasuo BAKKE, Tokyo (JP)

(21) Appl. No.: 19/059,680

(22) Filed: Feb. 21, 2025

(30) Foreign Application Priority Data
Oct. 18, 2024 (JP) 2024-183289

(51) Int. Cl. G06Q 10/0833; G06Q 10/0631; G06Q 10/067; G06Q 10/087

(52) U.S. Cl. CPC G06Q 10/0833; G06Q 10/06315; G06Q 10/067; G06Q 10/087

(57) ABSTRACT

A computer system holds supply chain plan information including at least one of a production plan, a sales plan, a delivery plan and a procurement plan, receives an order change request including a request for change in delivery date, conducts a simulation on the supply chain with a constraint of a changed delivery date to generate new supply chain plan information, and generates negotiation proposal information for partner companies in order to ask whether the partner companies grant the new supply chain plan information, sends the negotiation proposal information to the partner companies, conducts another simulation with new constraints in accordance with answers to the negotiation proposal information received from the partner companies to generate new supply chain plan information, generates an answer to the order change request that includes a changed delivery date based on the generated supply chain plan information and outputs the generated answer.

### CLAIM OF PRIORITY

The present application claims priority from Japanese patent application JP2024-183289 filed on Oct. 18, 2024, the content of which is hereby incorporated by reference into this application.

### BACKGROUND OF THE INVENTION

This invention relates to a technology for a supply chain, particularly a technique to support answering a delivery date to an order from a buyer.

When a company operating as a supplier in a supply chain receives an order change request including a request to change the delivery date from a buyer, they check the availability to deal with the change in delivery date with not only their own production plan but also their partner companies such as upstream suppliers, staffing agencies, and transport companies before answering the delivery date to the buyer.

For example, WO 2024/079843 A states: In order to address the problem of increasing the possibility of arriving at an agreement on the basis of an agreement candidate plan provided in a negotiation, this negotiation device includes: a provision reason appending unit for appending a provision reason to an agreement candidate plan to be provided to a first negotiation subject in a first negotiation with the first negotiation subject; and an agreement candidate plan provision unit for providing, to the first negotiation subject, the agreement candidate plan to which a provision reason has been appended (Abstract).

### SUMMARY OF THE INVENTION

When a supplier company is requested by a buyer company to bring forward the delivery date, for example, they revise their existing plans including the sales plan, the production plan, the delivery plan, and the procurement plan to grant the request. If determining that the revised plans are feasible, they answer that they accept bringing forward the delivery date and if not determining, they further revise the plans and provide a feasible delivery date.

In this connection, the supplier company may need to make inquiries to their partner companies in order to determine whether the individual plans are feasible. For example, to realize the procurement plan, they need to ask an upstream supplier company (Tier2 supplier) whether they can accelerate the delivery of necessary components. To realize the delivery plan, they need to ask a transport company whether they can transport the product as requested. To realize the production plan, they need to ask a staffing agency whether they can send workers as requested.

When some partner company cannot accept the initially revised plan, the supplier company may have to revise the plans and make inquiries to the partner companies for a number of times until the plans are accepted. The supplier company can generate easy plans for the partner companies in order to reduce the time and effort of repeating inquiries; however, answering “we cannot grant your request” regardless of a possibility to be able to deal with the requested delivery date may cause a penalty fee or diminish the buyer company's satisfaction.

In another case where the supplier company does not receive an answer from some partner company, they cannot inform the buyer company of a delivery date and because of it, they may lose the chance of a sale.

In order to solve at least one of the foregoing problems, one embodiment of this invention is a delivery date answering support method to be executed by a computer system including a processor and a storage device, the storage device holding supply chain plan information including at least one of a production plan of a product in a supply chain, a sales plan of the product, a delivery plan of the product, and a procurement plan of a component to produce the product, and the delivery date answering support method comprising: a first step, in which the processor receives an order change request including a request for change in delivery date; a second step, in which the processor conducts a simulation on the supply chain with a constraint of a delivery date changed in accordance with the order change request to generate new supply chain plan information, and generates negotiation proposal information for partner companies in order to ask whether the partner companies grant the new supply chain plan information; a third step, in which the processor sends the negotiation proposal information to the partner companies; a fourth step, in which the processor conducts another simulation on the supply chain with new constraints in accordance with answers to the negotiation proposal information received from the partner companies to generate new supply chain plan information; and a fifth step, in which the processor generates an answer to the order change request that includes a changed delivery date based on the generated supply chain plan information and outputs the generated answer.

An aspect of this invention automates the process from revising a supply chain plan to negotiating the revised plan with partner companies, so that answering a satisfactory delivery date to a client's order change request can be supported.

Problems, configurations, and effects other than those described above are clarified in the following description of embodiments.

### BRIEF DESCRIPTION OF THE DRAWINGS

FIG. 1 is a block diagram illustrating an example of the functional configuration of a delivery date answering support system in the embodiment.

FIG. 2 is a block diagram illustrating an example of the hardware configuration for implementing the delivery date answering support system in the embodiment.

FIG. 3 is an explanatory diagram illustrating the general picture of the functionality of the delivery date answering support system in the embodiment.

FIG. 4 is a flowchart of an example of the processing of the delivery date answering support system in the embodiment.

FIG. 5A is an explanatory diagram of an example of master information held by the delivery date answering support system in the embodiment.

FIG. 5B is an explanatory diagram of an example of a production human resources—capability master included in the master information held by the delivery date answering support system in the embodiment.

FIG. 5C is an explanatory diagram of an example of an item master included in the master information held by the delivery date answering support system in the embodiment.

FIG. 5D is an explanatory diagram of an example of a site master included in the master information held by the delivery date answering support system in the embodiment.

FIG. 6A is an explanatory diagram of an example of supply chain plan information held by the delivery date answering support system in the embodiment.

FIG. 6B is an explanatory diagram of an example of a sales plan included in the supply chain plan information held by the delivery date answering support system in the embodiment.

FIG. 6C is an explanatory diagram of an example of a production plan included in the supply chain plan information held by the delivery date answering support system in the embodiment.

FIG. 6D is an explanatory diagram of an example of a delivery plan included in the supply chain plan information held by the delivery date answering support system in the embodiment.

FIG. 6E is an explanatory diagram of an example of a procurement plan included in the supply chain plan information held by the delivery date answering support system in the embodiment.

FIG. 7A is an explanatory diagram of an example of negotiation proposal information held by the delivery date answering support system in the embodiment.

FIG. 7B is an explanatory diagram of an example of human resource negotiation information included in the negotiation proposal information held by the delivery date answering support system in the embodiment.

FIG. 7C is an explanatory diagram of an example of transport negotiation information included in the negotiation proposal information held by the delivery date answering support system in the embodiment.

FIG. 7D is an explanatory diagram of an example of delivery date negotiation information included in the negotiation proposal information held by the delivery date answering support system in the embodiment.

FIG. 8A is an explanatory diagram of an example of partner companies' availability information held by the delivery date answering support system in the embodiment.

FIG. 8B is an explanatory diagram of an example of human resource availability information included in the partner companies' availability information held by the delivery date answering support system in the embodiment.

FIG. 8C is an explanatory diagram of an example of transport availability information included in the partner companies' availability information held by the delivery date answering support system in the embodiment.

FIG. 8D is an explanatory diagram of an example of delivery date availability information included in the partner companies' availability information held by the delivery date answering support system in the embodiment.

FIG. 9 is an explanatory diagram of an example of delivery date answer information for the buyer held by the delivery date answering support system in the embodiment.

FIGS. 10A and 10B are explanatory diagrams of an example of a user interface provided by the delivery date answering support system in the embodiment.

### DETAILED DESCRIPTION OF THE EMBODIMENTS

Hereinafter, an embodiment of this invention is described with reference to the drawings; however, the scope of this invention is not limited to the embodiment.

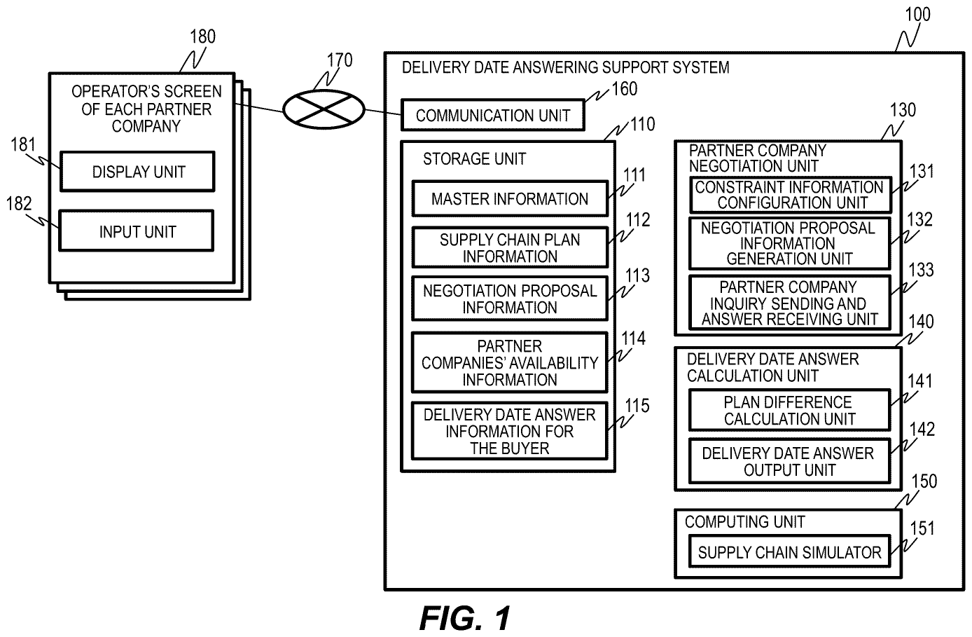

FIG. 1 is a block diagram illustrating an example of the functional configuration of the delivery date answering support system 100 in this embodiment.

The delivery date answering support system 100 includes a storage unit 110, a partner company negotiation unit 130, a delivery date answer calculation unit 140, a computing unit 150, and a communication unit 160.

The storage unit 110 includes master information 111, supply chain plan information 112, negotiation proposal information 113, partner companies' availability information 114, and delivery date answer information for the buyer 115. The specifics of the information will be described later. The storage unit 110 can be configured with a storage device such as a hard disk drive or a flash memory device.

The partner company negotiation unit 130 includes a constraint information configuration unit 131, a negotiation proposal information generation unit 132, and a partner company inquiry sending and answer receiving unit 133. The delivery date answer calculation unit 140 includes a plan difference calculation unit 141 and a delivery date answer output unit 142. The computing unit 150 includes a supply chain simulator 151. The processing of these units will be described later.

The communication unit 160 is an interface device for communicating with the terminal devices of the partner companies or external devices via a communication network 170. The communication unit 160 can use either wired or wireless communication.

The communication network 170 is connected from terminal devices of a plurality of partner companies. Each terminal device displays a partner company operator's screen 180. The partner company operator's screen 180 includes a display unit 181 and an input unit 182. The specifics of these will be described later.

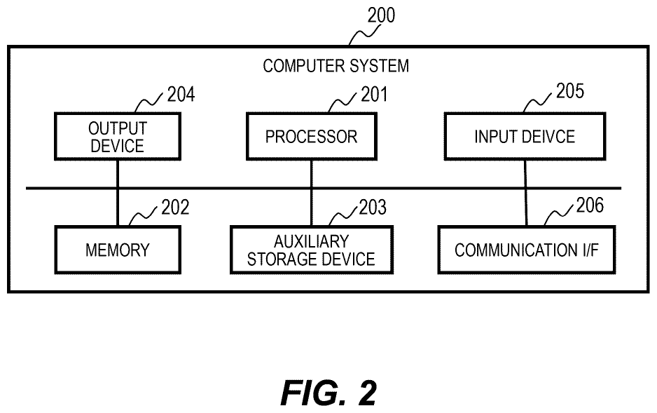

FIG. 2 is a block diagram illustrating an example of the hardware configuration for implementing the delivery date answering support system 100 in this embodiment.

The delivery date answering support system 100 in this embodiment in FIG. 1 can be implemented with a computer system. FIG. 2 illustrates a computer system 200 as an example of such a system.

The computer system 200 includes a processor 201, a memory (primary storage device) 202, an auxiliary storage device 203, an output device 204, an input device 205, and a communication interface (I/F) 206. The foregoing components are interconnected by a bus. The memory 202 and the auxiliary storage device 203 are storage devices and store programs and data to be used by the processor 201. The data shown in the storage unit 110 in FIG. 1 can be stored in the auxiliary storage device 203 and at least a part of it can be stored to the memory 202 when needed in processing.

The memory 202 can be a semiconductor memory and is used to hold programs being executed and data therefor. For example, the programs and data stored in the auxiliary storage device 203 are loaded to the memory 202 at the start-up or when needed. The processor 201 performs a variety of processing in accordance with the programs stored in the memory 202. The processor 201 operates in accordance with the programs to implement various functional units (e.g., the partner company negotiation unit 130, the delivery date answer calculation unit 140, and the computing unit 150 shown in FIG. 1).

The auxiliary storage device 203 can be a large-capacity storage device such as a hard disk drive or a solid-state drive and is used to hold programs and data for a long time. For example, the data in the storage unit 110 shown FIG. 1 and the programs for implementing the partner company negotiation unit 139, the delivery date answer calculation unit 140, and the computing unit 150 can be held in the auxiliary storage unit 123.

The processor 201 can be a single processing unit or a multiple processing units and can include a single or multiple arithmetic units or multiple processing cores. The processor 201 can be implemented as one or more central processing units, microprocessors, microcomputers, microcontrollers, digital signal processors, state machines, logic circuits, graphic processing units, systems-on-a-chip, and/or any devices that operates a signal in accordance with a control command.

The input device 205 is a hardware device for the user to input instructions and information. The output device 204 is a hardware device for presenting various images for inputting or outputting information and it can be a display device or a printing device, for example. The communication I/F 206 is an interface for connecting to the network. For example, the processor 201 controls the communication I/F 206 in accordance with a program to implement the functions of the communication unit 160.

The computer system 200 can include two or more processors 201. The functions of the delivery date answering support system 100 can be implemented on a plurality of computer systems 200. In that case, the plurality of computer systems 200 communicate with each other via a network. For example, some of the functions of the system in this embodiment can be implemented on one computer system 200 and the other functions can be implemented on another computer system 200.

The computer system 200 can be a server apparatus to be accessed by the users of the delivery date answering support system 100 (e.g., the supplier and its partner companies) via the communication network 170. In that case, the computer system 200 can be a virtual server in a so-called cloud and the computer system 200 illustrated in FIG. 2 is configured of computer resources in the cloud.

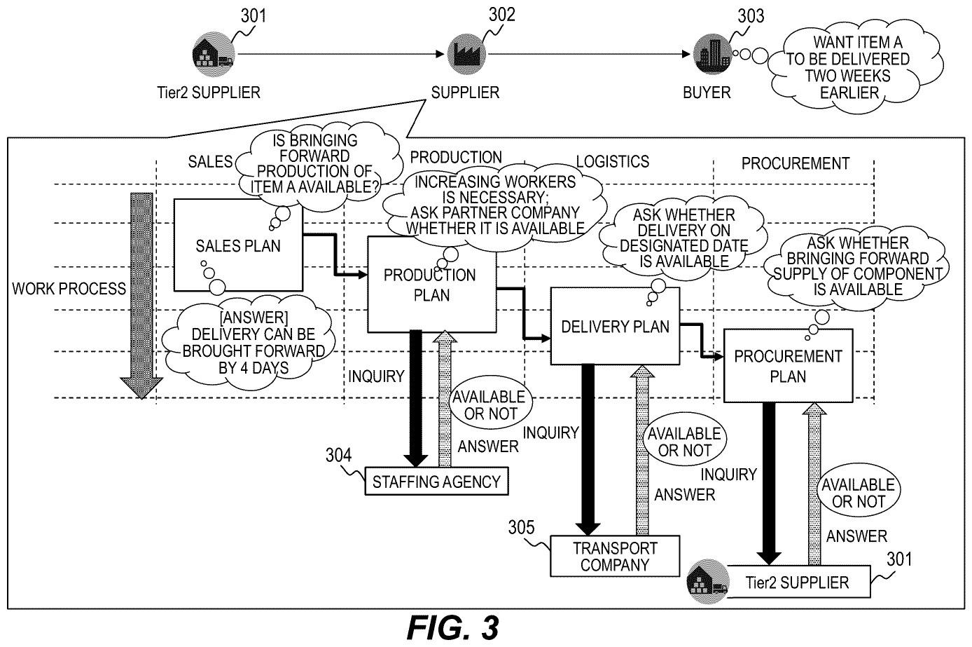

FIG. 3 is an explanatory diagram illustrating the general picture of the functionality of the delivery date answering support system 100 in this embodiment.

The embodiment describes application of the delivery date answering support system 100 to a supply chain including companies 301, 302, and 303. The company 302 is a supplier that produces a product and the company 303 is a buyer that purchases the product. The company 301 is an upstream supplier (Tier2 supplier) of the company 302 that produces a component to be mounted in the product of the company 302. In the following description, these companies are also referred to as Tier2 supplier 301, supplier 302, and buyer 303.

Although FIG. 3 shows one each of Tier2 supplier 301, supplier 302, and buyer 303 by way of example, the actual supply chain can include a plurality of companies for each of them. For example, the supplier 302 can procure the same or different components from a plurality of Tier2 suppliers 301 or can sell the same or different products to a plurality of buyers 303.

The foregoing designations such as “Tier2 supplier”, “supplier”, and “buyer” are descriptive names viewed from the viewpoint of the product produced by the company 302; however, the designations can be different depending on the product to be the viewpoint. For example, from the viewpoint of the product produced by the company 301 (or the component to be supplied to the company 302), the company 301 is a supplier of the component and the company 302 is a buyer and a company (not shown) that supplies a component or a material to be used to manufacture the component is a Tier2 supplier. Although this embodiment describes the processing in the case where the supplier 302 uses the delivery date answering support system 100, each company in the supply chain can use the delivery date answering support system 100 to execute the same processing.

This embodiment describes an example where the supplier 302 answers a delivery date to the buyer 303 with the delivery date answering support system 100 in response to a request from the buyer 303 to bring forward the delivery of the item A by two weeks from the initial sales plan.

For the supplier 302 to generate an answer to the request from the buyer 303, the sales division, production division, logistics division, and procurement division of the supplier 302 regenerate a sales plan, a production plan, a delivery plan, and a procurement plan, respectively, to address the request from the buyer 303.

On this occasion, the sales department has to ask the production department whether bringing forward the production of the item A is available. The production division has to ask a staffing agency 304 whether increasing the workers is available to bring forward the production. The logistics department has to ask a transport company 305 whether delivering the item A on the date designated by the buyer 303 is available. The procurement department has to ask the Tier2 supplier 301 whether bringing forward the supply of the component to be mounted in the item A is available.

The delivery date answering support system 100 in this embodiment automatically sends the above-described inquiries to the partner companies such as the staffing agency 304, the transport company 305, and the Tier2 supplier 301. If the delivery date answering support system 100 receives answers to the inquiries from all the partner companies, whichever the answers are affirmative or rejective, it generates a delivery date answer for the buyer 303 based on their answers. If the delivery date answering support system 100 does not receive an answer from any of the partner companies, it may regenerate plans supposed to be feasible, based on the previously generated plans. As a result, the system 100 may generate an answer such that the delivery date cannot be brought forward by two weeks but can by four days. The supplier 302 can answer a delivery date to the buyer 303 based on the generated answer.

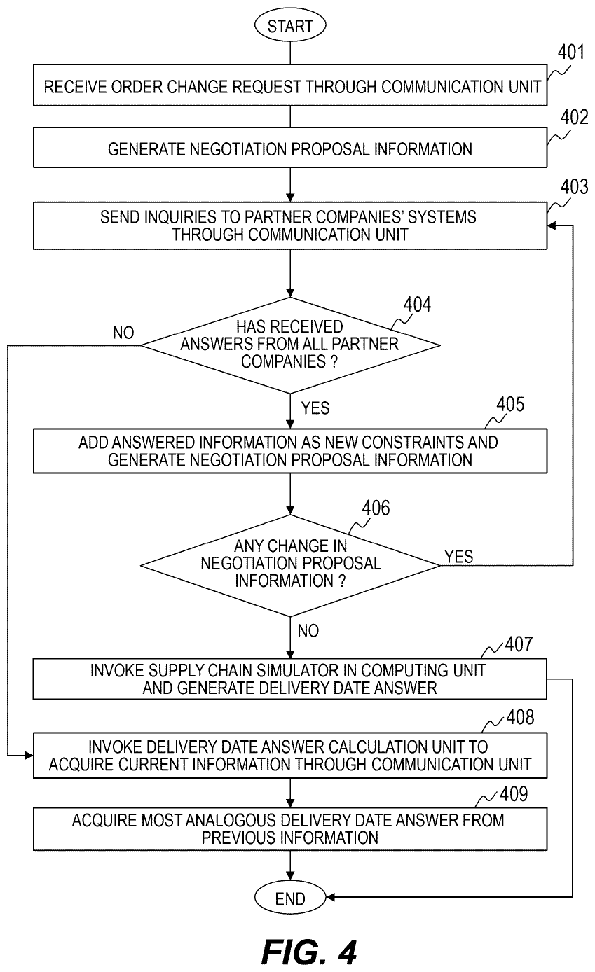

FIG. 4 is a flowchart of an example of the processing of the delivery date answering support system 100 in this embodiment.

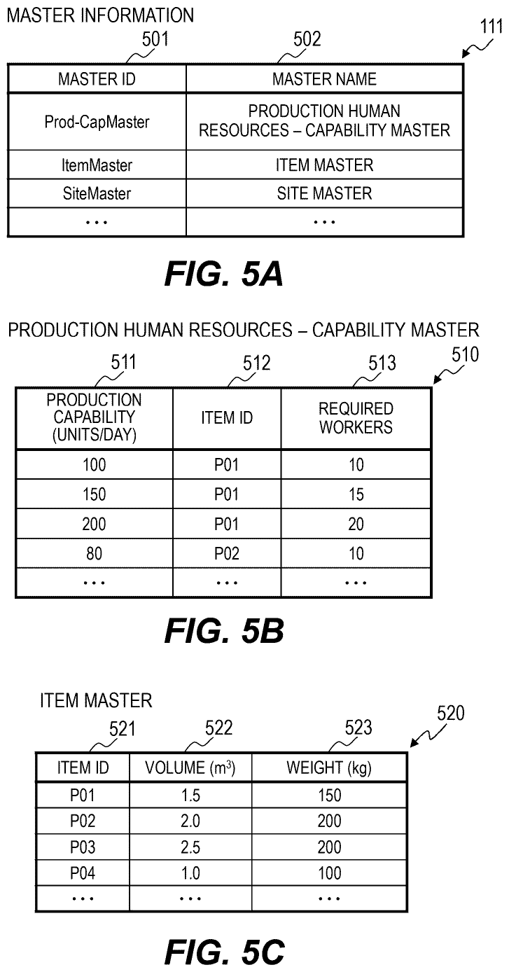

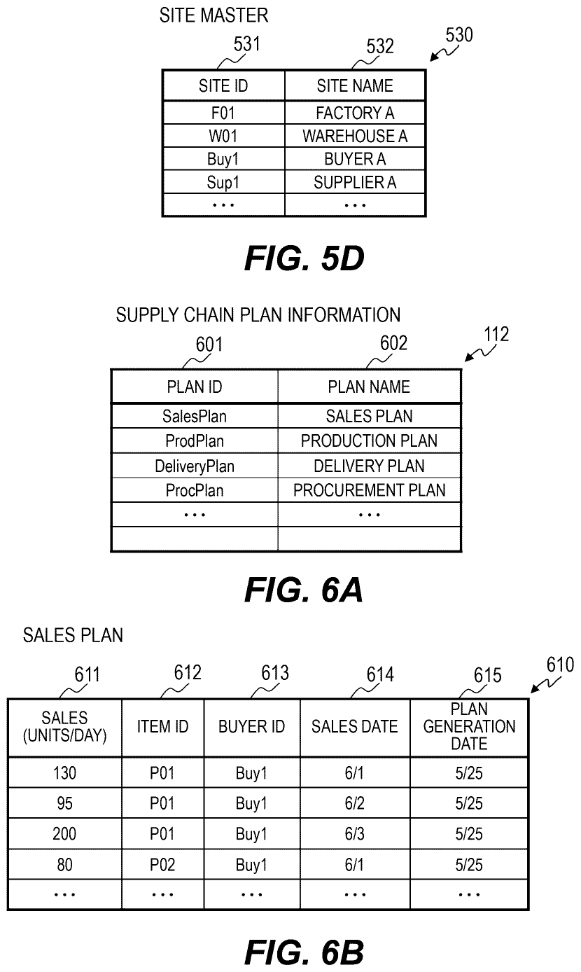

This section describes the processing to be performed when the supplier 302 shown in FIG. 3 receives an order change request including a request for change in delivery date from the buyer 303. Before the processing of FIG. 4 is started, the storage unit 10 holds at least the master information 111 shown in FIGS. 5A to 5D and already generated supply chain plan information 112. The processing of FIG. 4 can be started when an operator of the supplier 302 sends information on the order change request from the buyer 303 and a request to generate negotiation proposals to the delivery date answering support system 100 through the communication network 170. 39 First, the communication unit 160 receives the order change request (Step 401). In this example, the communication unit 160 receives a request from the buyer 303 to bring forward the delivery dates of the item A by two weeks through the supplier 302.

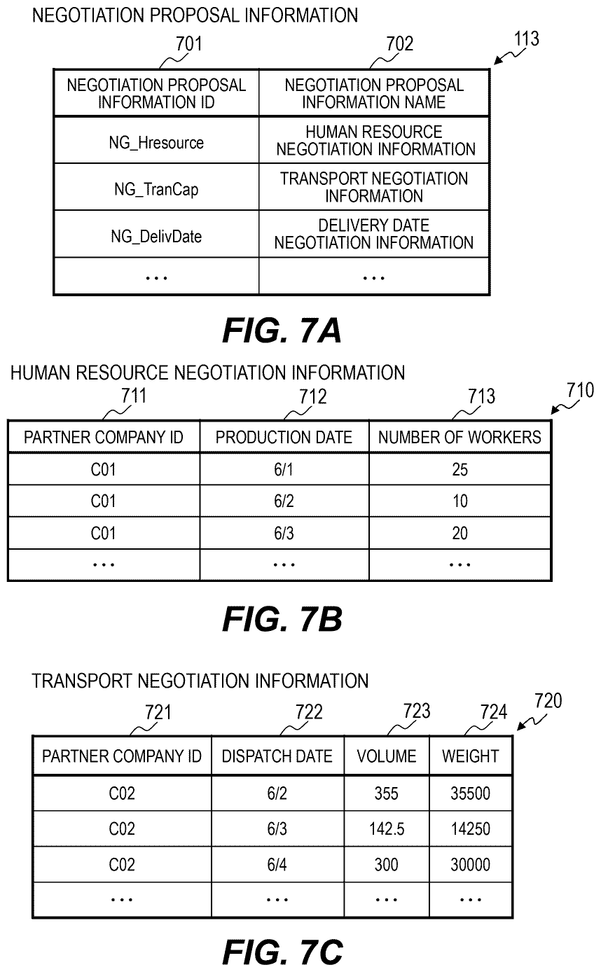

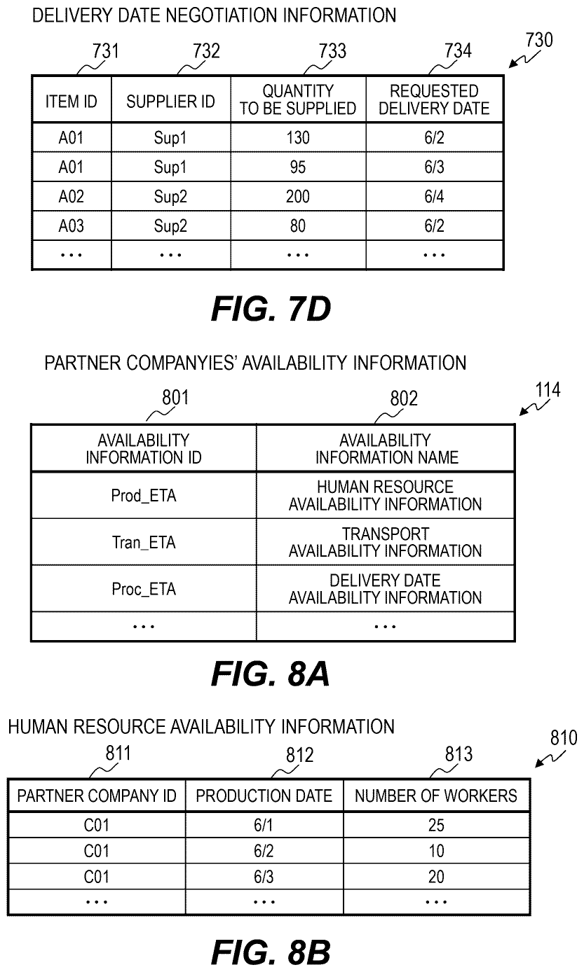

Next, the negotiation proposal information generation unit 132 generates negotiation proposal information 113 (Step 402). Examples of the generated negotiation proposals will be described later (see FIGS. 7A to 7D).

Next, the partner company inquiry sending and answer receiving unit 133 makes inquiries by sending the negotiation proposal information 113 to partner companies through the communication unit 160 (Step 403). If the partner company inquiry sending and answer receiving unit 133 receives answers from all the partner companies to which the inquiries are sent (Step 404: Yes), the negotiation proposal information generation unit 132 adds the acquired answers as new constraints and generates new negotiation proposal information 113 (Step 405).

The negotiation proposal information generation unit 132 determines whether the negotiation proposal information 113 generated at Step 405 includes any change from the one generated last time (Step 406). If it includes a change (S406: Yes), the processing returns to Step 403 and the partner company inquiry sending and answer receiving unit 133 makes inquiries by sending the negotiation proposal information 113 generated at Step 405 to the partner companies (Step 403).

If the negotiation proposal information 113 generated at Step 405 does not include any change from the one generated last time (Step 406: No), the supply chain simulator 151 conducts a simulation using the answers received from the partner companies as constraints and generates a delivery date answer (Step 407). At this step, the partner company negotiation unit 130 may generate the delivery date answer based on the supply chain plan information exhibiting the highest demand fulfillment rate in the supply chain plan information 112 generated in the course of repeating the loop from Step 403 to Step 406. The demand fulfillment rate will be described later. The generated delivery date answer is held as delivery date answer information for the buyer 115.

If the partner company inquiry sending and answer receiving unit 133 does not receive an answer from at least one of the partner companies at Step 404 (Step 404: No), the delivery date answer calculation unit 140 acquires the current information through the communication unit 160 (Step 408). For example, the delivery date answer calculation unit 140 may acquire the latest supply chain plan information 112 at the time of receipt of the order change request (namely, the ongoing plan at the time) and the information to be changed because of the order change request from the buyer 303 (e.g., information indicating bringing forward delivery dates).

The plan difference calculation unit 141 compares the current supply chain plan information 112 acquired at Step 408 with previous supply chain plan information 112 and acquires information on the delivery date answer most analogous to the current supply chain plan information 112 from the previous supply chain plan information 112 (Step 409). The acquired delivery date answer is held as delivery date answer information for the buyer 115.

Finally, the delivery date answer output unit 142 outputs the delivery date answer generated at Step 407 or the delivery date answer acquired at Step 409. In the case where the processing in FIG. 4 is performed based on information from the supplier 302 as described above, the delivery date answer is sent to the terminal device of the supplier 302 through the communication unit 160.

In the following, information held by the delivery date answering support system 100 is described and further, details of the processing in FIG. 4 are also described with reference to the information.

First, the master information 111 held by the delivery date answering support system 100 is described with reference to FIGS. 5A to 5D.

FIG. 5A is an explanatory diagram of an example of the master information 111 held by the delivery date answering support system 100 in this embodiment.

The master information 111 in FIG. 5A includes master IDs 501 and master names 502 as information indicating the contents of the master information 111. The example in FIG. 5A indicates that the master information 111 includes at least a production human resources—capability master, an item master, and a site master. Examples of the specifics of these masters are provided in FIGS. 5B to 5D.

FIG. 5B is an explanatory diagram of an example of the production human resources—capability master included in the master information 111 held by the delivery date answering support system 100 in this embodiment.

The production human resources—capability master 510 in FIG. 5B provides information indicating the production capability for each item and the production human resources required to realize the production capability and includes daily production capabilities 511, item IDs 512, and required workers 513, for example. Taking the first record as an example, it indicates that 10 workers are required to produce 100 units of the product having an item ID P01.

FIG. 5C is an explanatory diagram of an example of the item master included in the master information 111 held by the delivery date answering support system 100 in this embodiment.

The item master 520 in FIG. 5C provides information indicating the size and the weight of each product item and includes item IDs 521, volumes 522, and weights 523, for example. Taking the first record as an example, it indicates that the product having an item ID P01 has a volume of 1.5 cubic meters and a weight of 150 kilograms.

FIG. 5D is an explanatory diagram of an example of the site master included in the master information 111 held by the delivery date answering support system 100 in this embodiment.

The site master 530 in FIG. 5D provides information indicating the sites included in the supply chain and includes site IDs 531 and site names 532, for example. The example in FIG. 5D indicates that the supply chain includes sites such as Factory A, Warehouse A, Buyer A, and Supplier A and these sites are identified by the IDs (identifiers) such as F01, W01, Buy1, and Sup1. For example, Supplier A, Factory A, and Buyer A in FIG. 5D can respectively be the Tier2 supplier 301, the supplier 302, and the buyer 303 in FIG. 3.

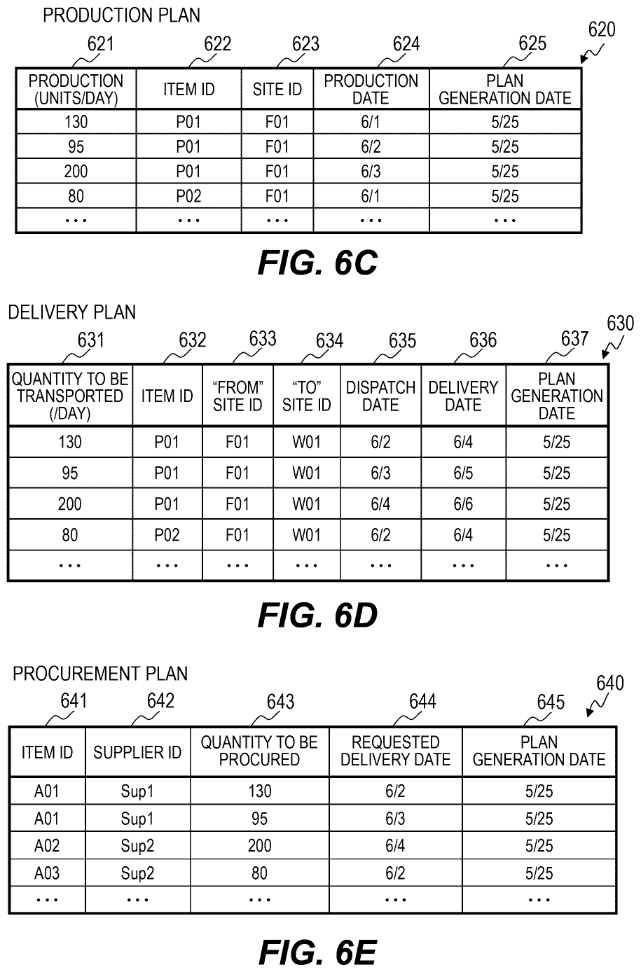

Next, the supply chain plan information 112 held by the delivery date answering support system 100 is described with reference to FIGS. 6A to 6E.

FIG. 6A is an explanatory diagram of an example of the supply chain plan information 112 held by the delivery date answering support system 100 in this embodiment.

The supply chain plan information 112 in FIG. 6A includes plan IDs 601 and plan names 602 as information indicating the contents of the supply chain plan information 112. The example in FIG. 6A indicates that the supply chain plan information 112 includes at least a sales plan, a production plan, a delivery plan, and a procurement plan. These are the sales plan, production plan, delivery plan, and procurement plan of the supplier 302 shown in FIG. 3. Examples of the specifics of these plans are provided in FIGS. 6B to 6E.

FIG. 6B is an explanatory diagram of an example of the sales plan included in the supply chain plan information 112 held by the delivery date answering support system 100 in this embodiment.

The sales plan 610 in FIG. 6B provides information on the plans to sell the produced products and includes sales in units 611, item IDs 612, buyer IDs 613, sales dates 614, and plan generation dates 615, for example. The example in FIG. 6B indicates that the plans described in the following were generated and all the plans were generated on May 25. The plans are: to sell 130 units of the product having an item ID P01 on June 1, to sell 95 units on June 2, and to sell 200 units on June 3 to the buyer having a buyer ID Buy1 (e.g., Buyer A in FIG. 5D, which can be the buyer 303 in FIG. 3), and further to sell 80 units of the product having an item ID P02 on June 1 to the same buyer.

FIG. 6C is an explanatory diagram of an example of the production plan included in the supply chain plan information 112 held by the delivery date answering support system 100 in this embodiment.

The production plan 620 in FIG. 6C provides information on the plans to produce products and includes production in units 621, item IDs 622, site IDs 623, production dates 624, and plan generation dates 625, for example. The example in FIG. 6C indicates that the plans described in the following were generated and all the plans were generated on May 25. The plans are: to produce 130 units of the product having an item ID P01 on June 1, to produce 95 units on June 2, and to produce 200 units on June 3 at the site having a site ID F01 (e.g., Factory A in FIG. 5D, which can be the supplier 302 in FIG. 3), and further to produce 80 units of the product having an item ID P02 on June 1 at the same site.

FIG. 6D is an explanatory diagram of an example of the delivery plan included in the supply chain plan information 112 held by the delivery date answering support system 100 in this embodiment.

The delivery plan 630 in FIG. 6D provides information on the plans to transport the produced products and includes quantities to be transported 631, item IDs 632, “From” site IDs 633, “To” site IDs 634, dispatch dates 635, delivery dates 636, and plan generation dates 637, for example.

The first to third records in the example in FIG. 6D indicate plans to transport the product having an item ID P01 from the site having a site ID F01 (e.g., Factory A in FIG. 5D) to the site having a site ID W01 (e.g., Warehouse A in FIG. 5D). According to these plans, 130 units of the product are dispatched on June 2, 95 units on June 3, and 200 units on June 4 from Factory A to be delivered to Warehouse A two days layer from the dispatch dates.

The fourth record indicates a plan to transport the product having an item ID P02 from the site having a site ID F01 to the site having a site ID W01. According to this plan, 80 units of the product are dispatched on June 2 from Factory A to be delivered to Warehouse A two days layer.

The example in FIG. 6D also indicates that these plans were all generated on May 25.

FIG. 6E is an explanatory diagram of an example of the procurement plan included in the supply chain plan information 112 held by the delivery date answering support system 100 in this embodiment.

The procurement plan 640 in FIG. 6E provides information on the plans to procure components required to produce products and includes item IDs 641, supplier IDs 642, quantities to be procured 643, requested delivery dates 644, and plan generation dates 645, for example. The item IDs 641 are identification information on the components to be procured and the supplier IDs 642, the quantities to be procured 643, and the requested delivery dates 644 are the identification information on the suppliers of the components (e.g., the Tier2 supplier 301 in FIG. 3), the quantities of the components to be procured, and the dates requested to receive the components.

The first and second records in the example in FIG. 6E indicate plans to procure or receive 130 pieces of the component having an item ID A01 on June 2 and 95 pieces on June 3 from the Tier2 supplier having a supplier ID Sup1. The third record indicates a plan to procure or receive 200 pieces of the component having an item ID A02 on June 4 from the Tier2 supplier having a supplier ID Sup2. The fourth record indicates a plan to procure or receive 80 pieces of the component having an item ID A03 on June 2 from the Tier2 supplier having a supplier ID Sup2.

The example in FIG. 6E also indicates that these plans were all generated on May 25.

Although the method of generating the supply chain plan information 112 is not limited, the supply chain simulator 151 can conduct a simulation to generate the supply chain plan information 112. For example, the supply chain simulator 151 may conduct a simulation based on the constraints on the delivery dates, facilities, human resources, transport, procurement of components, and the like. This simulation can be the one that outputs a sales plan, a production plan, a delivery plan, and a procurement plan satisfying input constraints on the sales (e.g., when, how many of what item should be sold), constraints on the production (e.g., constraints on the available facilities and workers), constraints on the transport (e.g., constraints on the weight and volume of the goods that can be transported), constraints on the procurement (e.g., how many of what component can be procured by when from Tier2 suppliers). Specifically, publicly known means such as a supply chain planning (SCP) solution can be used to generate the supply chain plan information 112.

In this embodiment, the processing in FIG. 4 is executed when an order change request such as a request to bring forward a delivery date is received after supply chain plan information 112 is generated in accordance with initial constraints. As will be described later, the supply chain simulator 151 generates new plans to address the order change request at Steps 402, 405, and 407 and stores the new plans as the supply chain plan information 112. At this time, the information on the previously generated plans is not deleted and new plans are added to the supply chain plan information 112 together with the plan generation dates.

Next, the negotiation proposal information 113 held by the delivery date answering support system 100 is described with reference to FIGS. 7A to 7D.

FIG. 7A is an explanatory diagram of an example of the negotiation proposal information 113 held by the delivery date answering support system 100 in this embodiment.

The negotiation proposal information 113 is information generated to ask each partner company whether they can accept the generated supply chain plan information 112. The negotiation proposal information 113 in FIG. 7A includes negotiation proposal information IDs 701 and negotiation proposal information names 702 as information indicating the contents of the negotiation proposal information 113. The example in FIG. 7A indicates that the negotiation proposal information 113 includes at least human resource negotiation information, transport negotiation information, and delivery date negotiation information. Examples of the specifics of these plans are provided in FIGS. 7B to 7D.

FIG. 7B is an explanatory diagram of an example of the human resource negotiation information included in the negotiation proposal information 113 held by the delivery date answering support system 100 in this embodiment.

The human resource negotiation information 710 in FIG. 7B provides information on the negotiation proposal to negotiate with a staffing agency of a partner company that sends human resources to be engaged in production to send a required number of workers on each production date; the information 710 includes partner company IDs 711, production dates 712, and numbers of workers 713, for example. 80 The example in FIG. 7B indicates a proposal to negotiate with the staffing agency having a partner company ID C01 to send 25 workers on June 1, 10 workers on June 2, and 20 workers on June 3 in order to produce products.

FIG. 7C is an explanatory diagram of an example of the transport negotiation information included in the negotiation proposal information 113 held by the delivery date answering support system 100 in this embodiment.

The transport negotiation information 720 in FIG. 7C provides information on the negotiation proposal to negotiate with a transport company of a partner company that transports produced products to a buyer to transport a desired amount (weight and volume) of products on each day; the information 720 includes partner company IDs 721, dispatch dates 722, volumes 723, and weights 724, for example.

The example in FIG. 7C indicates a proposal to negotiate with the transport company having a partner company ID C02 to transport products in a volume of 355 cubic meters and a weight of 35500 kilograms on June 2, products in a volume of 142.5 cubic meters and a weight of 14250 kilograms on June 3, and products in a volume of 300 cubic meters and a weight of 30000 kilograms on June 4.

FIG. 7D is an explanatory diagram of an example of the delivery date negotiation information included in the negotiation proposal information 113 held by the delivery date answering support system 100 in this embodiment.

The delivery date negotiation information 730 in FIG. 7D provides information on the negotiation proposal to negotiate with a supplier (Tier2 supplier) of a partner company that supplies components to be used to produce a product to supply desired quantities of desired components on each day; the information 730 includes item IDs 731, supplier IDs 732, quantities to be supplied 733, and requested delivery dates 734, for example.

The example in FIG. 7D is a proposal generated based on the procurement plan 640 shown in FIG. 6E. The item IDs 731, supplier IDs 732, quantities to be supplied 733, and requested delivery dates 734 correspond to the item IDs 641, supplier IDs 642, quantities to be procured 643, and requested delivery dates 644, respectively. This example is a plan generated to grant the buyer's request to change delivery dates and indicates that the plan is presented to the Tier2 supplier without change as a negotiation proposal.

The above-described negotiation proposal information 113 can be generated at Step 402 in FIG. 4. In the following, a detailed example of generating negotiation proposal information 113 at Step 402 in FIG. 4 is described.

First, the supply chain simulator 151 conducts a simulation based on the order change request to update the supply chain plan information 112. On this occasion, the supply chain simulator 151 specifies the items, the quantities to be produced, and the delivery dates specified in the order change request as constraints and removes the other constraints (such as the production constraints, the transport constraints, and the existing delivery date answer from the Tier2 supplier) to conduct the simulation. The negotiation proposal information generation unit 132 generates negotiation proposal information 113 based on the updated supply chain plan information 112. In the following, an example of the processing of the negotiation information generation unit 132 to generate negotiation proposal information 113 in the case where the production plan 620, delivery plan 630, and procurement plan 640 shown in FIGS. 6C to 6E are generated by the supply chain simulator 151.

The production plan 620 in FIG. 6C includes a plan to produce 130 units of the product having an item ID P01, which can be simply referred to as item P01 (the same applies to the other items), on June 1. According to the production human resources—capability master 510 in FIG. 5B, producing 100 units of the item P01 in one day requires 10 workers and producing 150 units requires 15 workers. This information teaches that 130 units of the item P01 can be produced on June 1, if 15 workers are hired on the day.

In similar, it can be found that hiring 10 workers to produce 95 units of the item P01 on June 2, 20 workers to produce 200 units of the item P01 on June 3, and 10 workers to produce 80 units of the item P02 on June 1 is sufficient. Totalizing the foregoing numbers on a daily basis, the required human resources are 25 workers on June 1, 10 workers on June 2, and 20 workers on June 3. The human resource negotiation information 710 in FIG. 7B is an example of the information to be presented to the partner company having a company ID C01 (e.g., the staffing agency 304) to negotiate to send the foregoing numbers of workers.

The delivery plan 630 in FIG. 6D includes a plan to dispatch 130 units of the item P01 on June 2. According to the item master 520 in FIG. 5C, one unit of the item P01 has a volume of 1.5 cubic meters and a weight of 150 kilograms. Using this information, the volume and the weight of 130 units of the item P01 are calculated as 195 cubic meters and 19500 kilograms, respectively.

In similar, the volume and the weight of 95 units of the item P01 to be dispatched on June 3 can be calculated as 142.5 cubic meters and 14250 kilograms, respectively; the volume and the weight of 200 units of the item P01 to be dispatched on June 4 can be calculated as 300 cubic meters and 30000 kilograms, respectively; and the volume and the weight of 80 units of the item P02 to be dispatched on June 2 can be calculated as 160 cubic meters and 16000 kilograms, respectively.

Totalizing the foregoing results on a daily basis, the amounts to be dispatched are 355 cubic meters and 35500 kilograms on June 2, 142.5 cubic meters and 14250 kilograms on June 3, and 300 cubic meters and 30000 kilograms on June 4. The transport negotiation information 720 in FIG. 7C is an example of the information to be presented to the partner company having a company ID C02 (e.g., the transport company 305) to negotiate to transport the above-described amounts of products.

With reference to the procurement plan 640 in FIG. 6E, the item IDs 641, the supplier IDs 642, the quantities to be procured 643, and the requested delivery dates 644 in this procurement plan 640 are used as the item IDs 731, the supplier IDs 732, and the quantities to be supplied 733, and the requested delivery dates 734 of the delivery date negotiation information 730 without change.

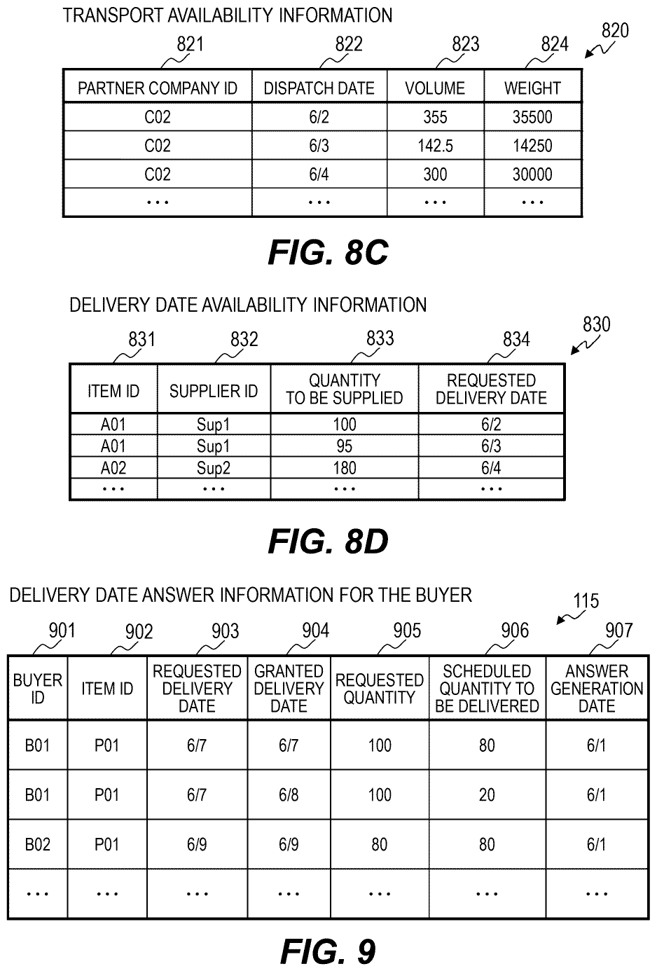

Next, the partner companies' availability information 114 held by the delivery date answering support system 100 is described with reference to FIGS. 8A to 8D.

FIG. 8A is an explanatory diagram of an example of the partner companies' availability information 114 held by the delivery date answering support system 100 in this embodiment.

The partner companies' availability information 114 in FIG. 8A includes availability information IDs 801 and availability information names 802 as information indicating the contents of the partner companies' availability information 114. The example in FIG. 8A indicates that the partner companies' availability information 114 includes at least human resource availability information, transport availability information, and delivery date availability information. Examples of the specifics of these plans are provided in FIGS. 8B to 8D.

FIG. 8B is an explanatory diagram of an example of the human resource availability information included in the partner companies' availability information 114 held by the delivery date answering support system 100 in this embodiment.

The human resource availability information 810 in FIG. 8B provides information indicating the answer to a negotiation proposal presented to a staffing agency and includes partner company IDs 811, production dates 812, and numbers of workers 813 for example. These correspond to the partner company IDs 711, the production dates 712, and the numbers of workers 713 in the human resource negotiation information 710 shown in FIG. 7B. The example in FIG. 8B indicates that the negotiation proposal shown in FIG. 7B was accepted by the staffing agency without change.

FIG. 8C is an explanatory diagram of an example of the transport availability information included in the partner companies'availability information 114 held by the delivery date answering support system 100 in this embodiment.

The transport availability information 820 in FIG. 8C provides information indicating the answer to a negotiation proposal presented to a transport company and includes partner company IDs 821, dispatch dates 822, volumes 823, and weights 824, for example. These correspond to the partner company IDs 721, the dispatch dates 722, the volumes 723, and the weights 724 in the transport negotiation information 720 shown in FIG. 7C. The example in FIG. 8C indicates that the negotiation proposal shown in FIG. 7C was accepted by the transport company without change.

FIG. 8D is an explanatory diagram of an example of the delivery date availability information included in the partner companies' availability information 114 held by the delivery date answering support system 100 in this embodiment.

The delivery date availability information 830 in FIG. 8D provides information indicating the answer to a negotiation proposal presented to a Tier2 supplier and includes item IDs 831, supplier IDs 832, quantities to be supplied 833, and requested delivery dates 834, for example. These correspond to the item IDs 731, the supplier IDs 732, the quantities to be supplied 733, and the requested delivery dates 734 in the delivery date negotiation information 730 shown in FIG. 7D.

The example in FIG. 8D indicates that at least a part of the negotiation proposal shown in FIG. 7D was not accepted by the Tier2 suppliers. Specifically, the example in FIG. 8D indicates that the Tier2 supplier answered that only 100 pieces of the component having an item ID A01 are available by June 2, although the negotiation proposal in FIG. 7D proposes 130 pieces. The example in FIG. 8D further indicates that the negotiation proposal to supply 95 pieces of the component having an item ID A01 by June 3 was accepted without change but the Tier2 supplier answered that only 180 pieces of the component having an item ID A02 are available by June 4, although the negotiation proposal in FIG. 7D proposes 200 pieces.

In the following, detailed example of generating negotiation proposal information 113 at Step 405 in FIG. 4 is described. The supply chain simulator 151 adds the acquired answers from the partner companies to the constraints, conducts a simulation again, and updates the supply chain plan information 112. The negotiation proposal information generation unit 132 regenerates negotiation proposal information 113 based on the updated supply chain plan information 112. This processing is the same as the one at Step 402 except that the constraints are added.

Among the examples of FIGS. 8B to 8D, the delivery date availability information 830 shown in FIG. 8D is different from the delivery date negotiation information 730 shown in FIG. 7D. As a result of adding constraints that did not exist previously like this case, the plan generated at Step 405 by the supply chain simulator 151 is more likely to be different from the one generated at Step 402. As a result, the negotiation proposal information 113 generated at Step 405 is also more likely to be different from the one generated at Step 402. If the generated negotiation proposal information 113 includes a change (Step 406: Yes), the processing returns to Step 403 and the newly generated negotiation proposal information 113 is sent to the partner companies.

In the above-described example, if the answer is the same as the negotiation proposal, the answer is added as a constraint as it is. However, if the demand fulfillment rate improves by easing the constraint, the eased constraint can be added. This option will be described later with the description of demand fulfillment rate.

If it is determined that no change is found in the negotiation proposal information after repeats of the above-described processing (Step 406: No), the processing proceeds to Step 407 because new supply chain plan information 112 is unlikely generated even if the processing were repeated more. At Step 407, the delivery date answer calculation unit 140 generates a delivery date answer for the buyer 303 based on the result of the simulation by the supply chain simulator 151.

FIG. 9 is an explanatory diagram of an example of the delivery date answer information for the buyer 115 held by the delivery date answering support system 100 in this embodiment.

The delivery date answer information for the buyer 115 includes buyer IDs 901, item IDs 902, requested delivery dates 903, granted delivery dates 904, requested quantities 905, scheduled quantities to be delivered 906, and answer generation dates 907.

The first record in FIG. 9 indicates that, in response to a request from the buyer having a buyer ID Buy1, which is also simply referred to as buyer Buy1 (the same applies to the other buyers), to deliver 100 units of the item P01 on June 7, the requested supplier (e.g., the supplier 302) answered that they can deliver 80 units of the item P01 on June 7.

In similar, the second record indicates that, in response to a request from the buyer Buy1 to deliver 100 units of the item P01 on June 7, the requested supplier answered that they can deliver 20 units of the item P01 on June 8.

Furthermore, the third record indicates that, in response to a request from the buyer Buy2 to deliver 80 units of the item P01 on June 9, the requested supplier answered that they can deliver 80 units of the item P01 on June 9.

Moreover, the example in FIG. 9 indicates that the answers of the foregoing three records were generated on June 1.

The granted delivery dates 904 and the scheduled quantities to be delivered 906 in the above-described example are generated based on the result of the simulation conducted by the supply chain simulator 151 based on the latest constraint information at the time when no change is found in the negotiation proposal information at Step 406. For example, the granted delivery dates 904 and the scheduled quantities to be delivered 906 are acquired from the sales dates 614 and the sales in units 611 for the combination of the item P01 and the buyer Buy1.

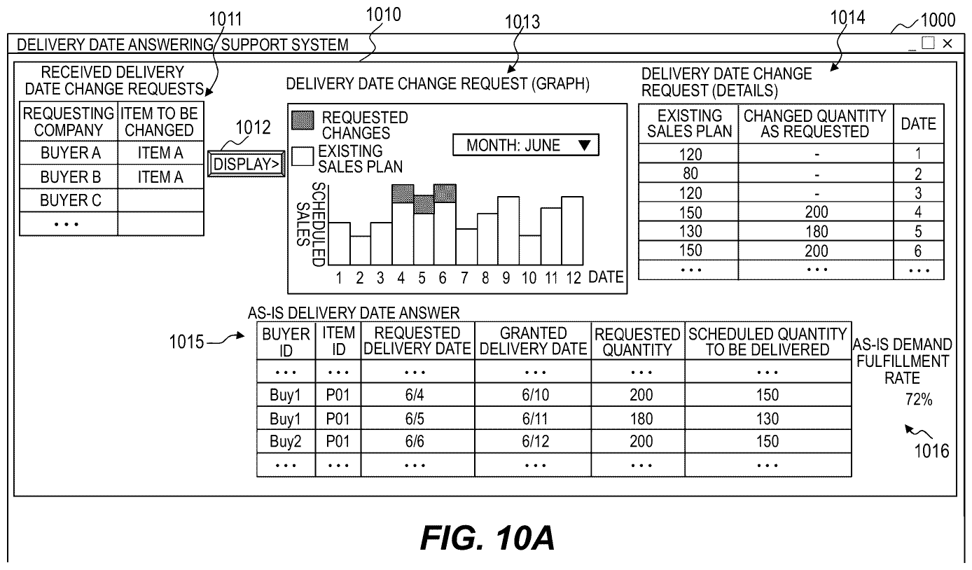

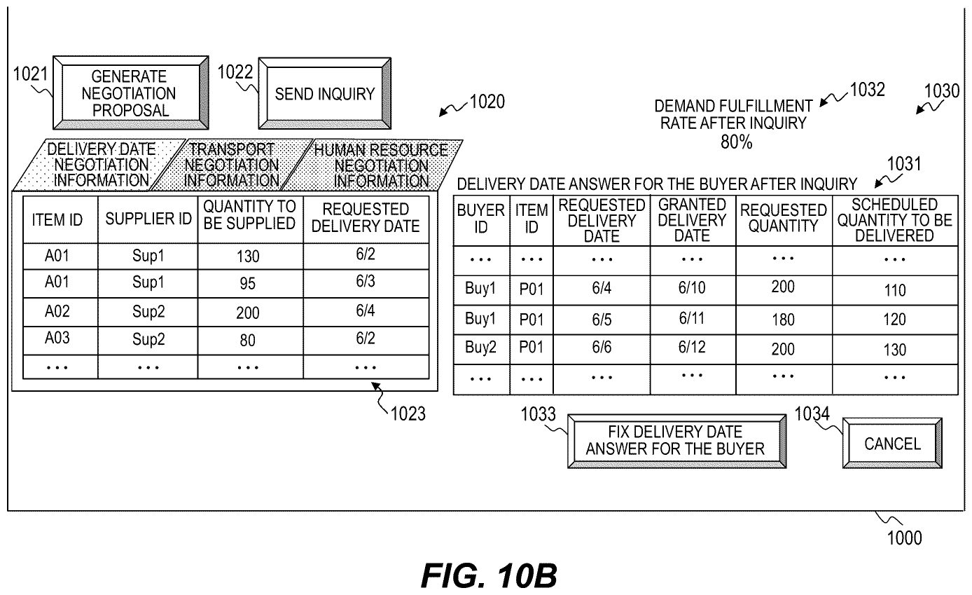

The delivery date answer output unit 142 outputs the generated delivery date answer information for the buyer 115. For example, the delivery date answer information for the buyer 115 is sent to the terminal device of the supplier 302 through the communication unit 160 and displayed on the operator's screen 180 of the terminal device. An example of a window to be displayed will be described later (see FIGS. 10A and 10B).

The delivery date answer calculation unit 140 may calculate an indicator representing the degree of fulfillment of the buyer's demand based on the delivery date answer information for the buyer 115. In this embodiment, the delivery date answer calculation unit 140 calculates a demand fulfillment rate as an example of such an indicator by the following method.

Regarding the first record, delivery of 80 units on June 7 was answered to the request to deliver 100 units on June 7; accordingly, the demand fulfillment rate is calculated as 80÷100×100=80 [%].

Regarding the second record, delivery of 20 units on June 8 was answered to the request to deliver 100 units on June 7. This means that the supplier cannot deliver even one unit on June 7 and accordingly, the demand fulfillment rate is calculated as 0%.

Regarding the third record, the answer was delivery as requested is available and accordingly, the demand fulfillment rate is calculated as 100%.

The delivery date answer calculation unit 140 may further calculate the overall demand fulfillment rate of the delivery date answer information for the buyer 115. For example, the overall demand fulfillment rate of the delivery date answer information

can be calculated as 60%, which is the average of the foregoing 80%, 0% and 100%.

As an option, the partner company negotiation unit 130 can generate a new negotiation proposal based on the demand fulfillment rate. An example of the processing is described in the following.

At Step 405 in FIG. 4, the supply chain simulator 151 may identify the subject on which the same answer as the negotiation proposal information 113 (or an answer accepting all requests) is received with reference to the partner companies' availability information 114 and ease the constraints on the identified subject to conduct a simulation. The delivery date answer calculation unit 140 calculates the demand fulfillment rate of the supply chain plan information 112 generated based on the simulation result and if the demand fulfillment rate is better than the previous one, the negotiation proposal information generation unit 132 generates negotiation proposal information 113 based on the eased constraints.

In the examples of FIGS. 7B to 7D and 8B to 8D, the delivery date availability information 830 is different from the delivery date negotiation information 730 and the values therein are added as new constraints. However, the human resource availability information 810 and the transport availability information 820 are the same as the human resource negotiation information 710 and the transport negotiation information 720. In this case, the negotiation proposal information generation unit 132 does not add the human resource availability information 810 and the transport availability information 820 to the constraints as they are but adds eased values as constraints.

For example, constraints of values larger than the values of the numbers of workers 813 for individual production dates 812 and constraints of values larger than the values of the volumes 823 and the weights 824 for individual dispatch dates 822 can be added. For this processing, predetermined amount to ease a constraint can be defined, such as increasing or decreasing the original value by 10%.

In the case where the procurement capability is a bottle neck of the supply chain in the above-described example, the possibility to improve the demand fulfillment rate is low even if conditions on the other capabilities are eased. In that case, the transport capability and the human resources proposed in the original negotiation proposal could be too much for the actual production volume; repeating the loop from Step 403 to Step 406 leads to generation of a supply chain plan consistent to the capability of the bottle neck.

In another case where the bottle neck is not the procurement capability, the demand fulfillment rate may improve by easing the conditions for other capabilities. Meanwhile, the human resource availability information 810 and the transport availability information 820 being the same as the negotiation proposals in the above-described example indicate that the actual human resource supply capability and transport capability still have rooms and there are possibilities to be able to answer severer requests. For this reason, easing the constraints may lead to generation of a supply chain plan having a higher demand fulfillment rate and acceptable for the partner companies.

Next, the processing in the case where the partner company inquiry sending and answer receiving unit 133 does not receive an answer from at least one of the partner companies at Step 404 (Step 404: No) is described.

At Step 408, the delivery date answer calculation unit 140 acquires current information. The current information means the latest sales plan 610, production plan 620, delivery plan 630, and procurement plan 640 generated at the last Step 402. The latest plans can be identified from the plan generation dates 615, 625, 637, and 645.

At Step 409, the plan difference calculation unit 141 in the delivery date answer calculation unit 140 acquires information most analogous to the current information acquired at Step 408 from the previous information (or the information older than the current information acquired at Step 408) included in the supply chain plan information 112. Although its specific method is not limited, an example of the method is described as follows.

Taking the production plan 620 as an example, if the plans having a plan generation date 625 of May 25 are the newest, the plans to produce 130 units of the item P01 on June 1, 95 units on June 2, and 200 units on June 3 at the site F01 are acquired as the current information.

The plan difference calculation unit 141 acquires plans analogous in production date 624 and production in units 621 from the plans having a plan generation date 625 earlier than May 25, an item ID 622 of P01, and a site ID 623 of F01. Regarding the production date 624, the date can be calculated as the number of days elapsed since the plan generation date 625. In that case, June 1, June 2, and June 3 in the example of FIG. 6C are calculated as 7 days later, 8 days later, and 9 days later, respectively.

For example, in the case where information on the previous plans such that the plan generation dates 625 are earlier than May 25, the item IDs 622 are P01, the site IDs are F01, the production in units 621 are 100 units on the seventh day from the plan generation date 625, 110 units on the eighth day, and 190 units on the eleventh day is acquired, the plan difference calculation unit 141 calculates the differences between the previous information and the current information.

Specifically, the plan difference calculation unit 141 may calculate the total of the square differences in production in units between the plans for the dates after the same number of days. In the case of the above-described example, the square difference of the seventh day is (130−100)\hat{ }2=900, the square difference of the eighth day is (95−110)\hat{ }2=255, the square difference of the ninth day is (200−0)\hat{ }2=40000, the square difference of the tenth day is (0−0)\hat{ }2=0, and the square difference of the eleventh day is (0−190)\hat{ }2=36100; the total of those square differences is 77225.

The plan difference calculation unit 141 calculates differences from the other previous information in the same way to determine the previous information having the smallest difference to be the most analogous previous information. Further, the delivery date answer calculation unit 140 acquires the delivery date answer corresponding to the most analogous previous information from the delivery date answer information for the buyer 115.

In this connection, the correspondence of the previous information to the delivery date answer can be determined based on the relation between the plan generation date 625 and the answer generation date 907. Specifically, the delivery date answer including the same date as the plan generation date 625 of the previous information in the answer generation date 907 can be acquired as a delivery date answer corresponding to the previous information. The delivery date answer acquired in this way is actually sent under a previous situation similar to the current situation and therefore, it is supposed to be feasible.

The delivery date answer output unit 142 outputs the acquired delivery date answer. For example, the acquired delivery date answer is sent to the terminal device of the supplier 302 through the communication unit 160 and displayed on the operator's screen 180 of the terminal device. An example of a window to be displayed will be described later (see FIGS. 10A and 10B).

FIGS. 10A and 10B are explanatory diagrams of an example of a user interface provided by the delivery date answering support system 100 in this embodiment.

The window 1000 in FIGS. 10A and 10B are examples of information displayed on the operator's screen 180 of a company (e.g., the supplier 302 in FIG. 3) using the delivery date answering support system 100. The displayed information is based on the information output by the delivery date answering support system 100 through the communication unit 160. In the example in FIGS. 10A and 10B, the window 1000 includes an as-is state display area 1010, a negotiation proposal display area 1020, and a delivery-date-answer-for-the-buyer display area 1030.

First, the as-is state display area 1010 is described. The as-is state display area 1010 displays an ongoing supply chain plan and a delivery date answer based on the received order change request. Specifically, the as-is state display area 1010 includes received delivery date change requests 1011, a “display” button 1012, a delivery date change request (graph) 1013, a delivery date change request (details) 1014, an as-is delivery date answer 1015, and an as-is demand fulfillment rate 1016.

When the supplier 302 receives an order change request including a request for change in delivery date from a buyer 303, identification information on the buyer 303 and the designated item is displayed in a list of received delivery date change requests 1011. When the operator of the supplier 302 selects one of the items in the displayed list and operates the “display” button 1012, the scheduled sales in units of the designated item according to the sales plan reflecting the delivery date changes are displayed in the delivery date change request (graph) 1013.

In the example of FIG. 10A, the quantities of the scheduled daily sales are displayed in a graph and the quantities increased because of the delivery date changes are hatched. The delivery date change request (details) 1014 displays specific numerical values of the data displayed in the delivery date change request (graph) 1013.

The specifics of the delivery date answer in the case where the delivery date change request is addressed without changing the ongoing plan are displayed in the as-is delivery date answer 1015 and the demand fulfillment rate under the conditions is displayed as the as-is demand fulfillment rate 1016. The as-is delivery date answer 1015 includes the same items as the delivery date answer information for the buyer 115 shown in FIG. 9, but the numerical values therein are based on the ongoing plan (in other words, numerical values at the time before executing the processing in FIG. 4). The changed delivery dates usually cannot be followed and cause a delay, unless the ongoing plan is changed. In the example of FIG. 10A, the as-is demand fulfillment rate 1016 is 72%.

Next, the negotiation proposal display area 1020 is described. The negotiation proposal display area 1020 displays a negotiation proposal generated by the delivery date answering support system 100. Specifically, the negotiation proposal display area 1020 includes a “generate negotiation proposal” button 1021, a “send inquiry” button 1022, and negotiation proposal information 1023.

For example, when the operator of the supplier 302 operates the “generate negotiation proposal” button 1021 after selecting at least one of the delivery date changes in the as-is state display area 1010, the delivery date answering support system 100 executes Step 402 in FIG. 4. The terminal device of the supplier 302 acquires the generated negotiation proposal information 113 from the delivery date answering support system 100 and displays it as negotiation proposal information 1023. Although the displayed negotiation proposal information 1023 in the example in FIG. 10B is delivery date negotiation information 730, transport negotiation information 720 or human resource negotiation information 710 can be displayed in response to a request from the operator.

When the operator checks the displayed negotiation proposal and operates the “send inquiry” button 102, the delivery date answering support system 100 executes the processing of Step 403 and the subsequent steps in FIG. 4. The terminal device of the supplier 302 acquires the delivery date answer generated at Step 407 or the delivery date answer acquired at Step 409 from the delivery date answering support system 100 and displays it in the delivery-date-answer-for-the-buyer display area 1030.

The delivery-date-answer-for-the-buyer display area 1030 includes a delivery date answer for the buyer after inquiry 1031, a demand fulfillment rate after inquiry 1032, a “fix delivery date answer for the buyer” button 1033, and a “cancel” button 1034.

The delivery date answer for the buyer after inquiry 1031 displays the delivery date answer the terminal device of the supplier 302 has acquired from the delivery date answering support system 100. In the example of FIG. 10B, the delivery date answer information for the buyer 115 shown in FIG. 9 is displayed. Furthermore, the demand fulfillment rate based on this delivery date answer is displayed as a demand fulfillment rate after inquiry 1032. The example in FIG. 10B shows “80%” as the demand fulfillment rate 1032, which it is not as high as 100% but is improved from the as-is demand fulfillment rate 1016.

When the operator checks the information and finds no problem, the operator operates the “fix delivery date answer for the buyer” button 1033. In this case, the terminal device of the supplier 302 sends a delivery date answer based on the delivery date answer information for the buyer 115 to the buyer 303. If the operator operates the “cancel” button 1034, the delivery date answer based on the delivery date answer information for the buyer 115 is not sent out. In this case, the operator may instruct the delivery date answering support system 100 to regenerate a negotiation plan with different conditions specified or manually amend the supply chain plan or the delivery date answer.

The system in the embodiment of this invention can be configured as follows.

(1) A computer system (e.g., the computer system 200 implementing the delivery date answering support system 100) including a processor (e.g., the processor 201) and a storage device (e.g., the memory 202 and the auxiliary storage device 203) executes a delivery date answering support method. The storage device holds supply chain plan information (e.g., the supply chain plan information 112) including at least one of a production plan (e.g., the production plan 620) of a product in a supply chain, a sales plan (e.g., the sales plan 610) of the product, a delivery plan (e.g., the delivery plan 630) of the product, and a procurement plan (e.g., the procurement plan 640) of a component to produce the product. The delivery date answering support method includes a first step (e.g., Step 401) in which the processor receives an order change request including a request for change in delivery date, a second step (e.g., Step 402) in which the processor conducts a simulation on the supply chain with a constraint of a delivery date changed in accordance with the order change request to generate new supply chain plan information, and generates negotiation proposal information (e.g., the negotiation proposal information 113) for partner companies in order to ask whether the partner companies grant the new supply chain plan information, a third step (e.g., Step 403) in which the processor sends the negotiation proposal information to the partner companies, a fourth step (e.g., Step 405) in which the processor conducts another simulation on the supply chain with new constraints in accordance with answers to the negotiation proposal information received from the partner companies to generate new supply chain plan information, and a fifth step (Step 407) in which the processor generates an answer to the order change request (e.g., the delivery date answer information for the buyer 115) that includes a changed delivery date based on the generated supply chain plan information and outputs the generated answer. 152 This configuration automates processing from reviewing the supply chain plan to address the order change request to negotiating with the partner companies to realize the plan and supports generation of a delivery date answer more satisfactory for the client.

(2) In the delivery date answering support method according to the foregoing (1), the negotiation proposal information for the partner companies includes at least one of information to ask whether human resources enough to follow the production plan included in the supply chain plan information are available (e.g., the human resource negotiation information 710), information to ask whether transport in accordance with the delivery plan included in the supply chain plan is available (e.g., the transport negotiation information 720), information to ask whether supply of the component in accordance with the procurement plan included in the supply chain plan information is available (e.g., the delivery date negotiation information 730) as information to ask whether the partner companies grant the new supply chain plan information.

This configuration automates the negotiation with the partner companies to address the revised supply chain plan.

(3) In the delivery date answering support method according to the foregoing (2), the processor generates new negotiation proposal information for the partner companies to ask whether the partner companies grant the new supply chain information in the fourth step. The processor further executes the third step again by sending the new negotiation proposal information generated at the fourth step to the partner companies, repeatedly executes the third step and the fourth step until a predetermined condition is satisfied, and executes the fifth step in a case where the predetermined condition is satisfied (e.g., Step 406: No).

This configuration supports generation of a delivery date answer more satisfactory for the client.

(4) In the delivery date answering support method according to the foregoing (3), the processor calculates a demand fulfillment rate of the new supply chain plan information in the fourth step, and generates an answer to the order change request that includes a changed delivery date based on supply chain plan information having a highest demand fulfillment rate in generated supply chain plan information and outputs the generated answer in the fifth step.

This configuration supports generation of a delivery date answer more satisfactory for the client.

(5) In the delivery date answering support method according to the foregoing (4), the processor eases a constraint for a partner company that has granted the supply chain plan information in an answer to the negotiation plan information before conducting another simulation to generate new supply chain plan information and generates new negotiation plan information to ask whether the partner companies grant the new supply chain plan information in a case where a demand fulfillment rate of the new supply chain plan information is better than a demand fulfillment rate calculated before easing the constraint in the fourth step.

This configuration supports generation of a delivery date answer more satisfactory for the client.

(6) In the delivery date answering support method according to the foregoing (3), the processor determines that the predetermined condition is satisfied in a case where the new negotiation plan information generated in the fourth step is not changed from negotiation plan information generated last time.

This configuration supports generation of a delivery date answer more satisfactory for the client.

(7) In the delivery date answering support method according to the foregoing (1), the supply chain plan information includes previously generated supply chain information, the storage device further includes previously generated answer information on answers to order change requests (e.g., the delivery date answer information for the buyer 115), and the delivery date answering support method further includes a sixth step (e.g., Step 408) in which the processor acquires supply chain plan information analogous to the new supply chain plan information from the previously generated supply chain plan information in a case where an answer to the negotiation proposal information sent at the third step is not received from at least one of the partner companies (e.g., Step 404: No) and a seventh step (e.g., Step 409) in which the processor acquires and outputs answer information corresponding to the supply chain plan information acquired at the sixth step from the previously generated answer information on answers to order change requests.

This configuration prevents losing a chance of a sale through answering a feasible delivery date even if an answer is not received from a partner company.

(8) In the delivery date answering support method according to the foregoing (7), the supply chain plan information includes information on items, quantity to be produced, production sites, and production dates of the products to be produced and generation dates of the supply chain plan information and the previously generated answer information on answers to order change requests includes generation dates of answer information. The processor acquires supply chain plan information analogous in item, quantity to be produced, production site, and number of days from a generation date of the supply chain plan information to a production date in the sixth step and acquires answer information including a generation date corresponding to a generation date of the supply chain plan information acquired at the sixth step in the seventh step.

This configuration enables acquisition of a feasible delivery date answer.

It should be noted that this invention is not limited to the above-described embodiment but includes various modifications. For example, the above-described embodiment provides details for the sake of better understanding of this invention; they are not limited to those including all the configurations as described. A part of the configuration of an embodiment may be replaced with a configuration of another embodiment or a configuration of an embodiment may be incorporated to a configuration of another embodiment. A part of the configuration of an embodiment may be added, deleted, or replaced by that of a different configuration.

The above-described configurations, functions, processing units, and processing means, for all or a part of them, may be implemented by hardware: for example, by designing an integrated circuit. The above-described configurations and functions may be implemented by software, which means that a processor interprets and executes programs for providing the functions. The information of programs, tables, and files to implement the functions may be stored in a storage device such as a memory, a hard disk drive, or a solid-state drive (SSD), or a computer-readable non-transitory data storage medium such as an IC card, an SD card, or a DVD.

The drawings include control lines and information lines as considered necessary to explain the embodiments but do not include all control lines or information lines in the actual products. It can be considered that most of all components are interconnected.

What is claimed is:

1. A delivery date answering support method to be executed by a computer system including a processor and a storage device,
the storage device holding supply chain plan information including at least one of a production plan of a product in a supply chain, a sales plan of the product, a delivery plan of the product, and a procurement plan of a component to produce the product, and
the delivery date answering support method comprising:
a first step, in which the processor receives an order change request including a request for change in delivery date;
a second step, in which the processor conducts a simulation on the supply chain with a constraint of a delivery date changed in accordance with the order change request to generate new supply chain plan information, and generates negotiation proposal information for partner companies in order to ask whether the partner companies grant the new supply chain plan information;
a third step, in which the processor sends the negotiation proposal information to the partner companies;
a fourth step, in which the processor conducts another simulation on the supply chain with new constraints in accordance with answers to the negotiation proposal information received from the partner companies to generate new supply chain plan information; and
a fifth step, in which the processor generates an answer to the order change request that includes a changed delivery date based on the generated supply chain plan information and outputs the generated answer.

2. The delivery date answering support method according to claim 1, wherein the negotiation proposal information for the partner companies includes at least one of information to ask whether human resources enough to follow the production plan included in the supply chain plan information are available, information to ask whether transport in accordance with the delivery plan included in the supply chain plan is available, information to ask whether supply of the component in accordance with the procurement plan included in the supply chain plan information is available as information to ask whether the partner companies grant the new supply chain plan information.

3. The delivery date answering support method according to claim 2,
wherein, in the fourth step, the processor generates new negotiation proposal information for the partner companies to ask whether the partner companies grant the new supply chain information, and
wherein the processor is configured to:
execute the third step again by sending the new negotiation proposal information generated at the fourth step to the partner companies;
repeatedly execute the third step and the fourth step until a predetermined condition is satisfied; and
execute the fifth step in a case where the predetermined condition is satisfied.

4. The delivery date answering support method according to claim 3,
wherein, in the fourth step, the processor calculates a demand fulfillment rate of the new supply chain plan information, and
wherein, in the fifth step, the processor generates an answer to the order change request that includes a changed delivery date based on supply chain plan information having a highest demand fulfillment rate in generated supply chain plan information and outputs the generated answer.

5. The delivery date answering support method according to claim 4, wherein, in the fourth step, the processor eases a constraint for a partner company that has granted the supply chain plan information in an answer to the negotiation plan information in conducting another simulation to generate new supply chain plan information and generates new negotiation plan information to ask whether the partner companies grant the new supply chain plan information in a case where a demand fulfillment rate of the new supply chain plan information is better than a demand fulfillment rate calculated before easing the constraint.

6. The delivery date answering support method according to claim 3, wherein the processor is configured to determine that the predetermined condition is satisfied in a case where the new negotiation plan information generated in the fourth step is not changed from negotiation plan information generated last time.

7. The delivery date answering support method according to claim 1,
wherein the supply chain plan information includes previously generated supply chain information,
wherein the storage device includes previously generated answer information on answers to order change requests, and
wherein the delivery date answering support method further comprises:
a sixth step, in which the processor acquires supply chain plan information analogous to the new supply chain plan information from the previously generated supply chain plan information in a case where an answer to the negotiation proposal information sent at the third step is not received from at least one of the partner companies; and
a seventh step, in which the processor acquires and outputs answer information corresponding to the supply chain plan information acquired at the sixth step from the previously generated answer information on answers to order change requests.

8. The delivery date answering support method according to claim 7,
wherein the supply chain plan information includes information on items, quantity to be produced, production sites, and production dates of the products to be produced and generation dates of the supply chain plan information,
wherein the previously generated answer information on answers to order change requests includes generation dates of answer information,
wherein, in the sixth step, the processor acquires supply chain plan information analogous in item, quantity to be produced, production site, and number of days from a generation date of the supply chain plan information to a production date, and
wherein, in the seventh step, the processor acquires answer information including a generation date corresponding to a generation date of the supply chain plan information acquired at the sixth step.

9. A delivery date answering support system comprising:
a processor; and
a storage device,
wherein the storage device holds supply chain plan information including at least one of a production plan of a product in a supply chain, a sales plan of the product, a delivery plan of the product, and a procurement plan of a component to produce the product, and
wherein the processor is configured to:
receive an order change request including a request for change in delivery date;
conduct a simulation on a supply chain with a constraint of a delivery date changed in accordance with the order change request to generate new supply chain plan information;
generate negotiation proposal information for partner companies in order to ask whether the partner companies grant the new supply chain plan information;
send the negotiation proposal information to the partner companies;
conduct another simulation on the supply chain with new constraints in accordance with answers to the negotiation proposal information received from the partner companies to generate new supply chain plan information;
generate an answer to the order change request that includes a changed delivery date, based on the generated supply chain plan information; and
output the generated answer.
